(19) United States
(12) Patent Application Publication
(10) Pub. No.: US 2025/0338956 A1
(43) Pub. Date: Nov. 6, 2025

(54) FURNITURE MODULE AND A METHOD OF ASSEMBLING A FURNITURE MODULE

(71) Applicant: Inter IKEA Systems B.V., Delft (NL)

(72) Inventors: Mats LUNDQVIST, Lönsboda (SE); Benny ANDERSSON, Älmhult (SE)

(21) Appl. No.: 18/865,724

(22) PCT Filed: May 11, 2023
(86) PCT No.: PCT/SE2023/050463

§ 371 Date: Nov. 14, 2024

(30) Foreign Application Priority Data
May 16, 2022 (SE) 2250588-7

(51) Int. Cl. A47B 47/04; A47B 61/00; A47B 91/02; F16B 12/44

(52) U.S. Cl. CPC A47B 47/042; A47B 91/024; F16B 12/44; A47B 61/00

(57) ABSTRACT

A furniture module including two opposing side walls being interconnected by a rear wall panel arrangement, and a shelf configured to be positioned between the side walls, preferably between a respective top portion of the side walls. The shelf is provided with a front dowel on each side of the shelf and a central dowel on each side of the shelf, wherein the front dowel on each side of the shelf extends a first distance from the respective side of the shelf and the central dowel extends a second distance from the respective side of the shelf, wherein the first distance is greater than the second distance.

### FIELD OF INVENTION

The invention relates to a furniture module comprising two opposing side walls being interconnected by a rear wall panel arrangement, and a shelf configured to be positioned between the side walls, preferably between a respective top portion of the side walls.

The invention also relates to a method of attaching a shelf between two opposing side walls of a furniture module in which the two opposing side walls are interconnected by a flexible rear wall panel arrangement

### TECHNICAL BACKGROUND

Although it is convenient and cost-effective to transport furniture module in non-assembled state and then assemble then at the site of intended use, some furniture module, such as wardrobes, are difficult to assemble at home due to their size. Wardrobes, e.g., are often difficult to assemble by a single person, and it is especially difficult to do so when there is limited space available, and the wardrobe needs to be assembled while standing in an upright position from the very beginning. This need to assemble the wardrobe in a standing position may e.g., be occasioned by the lack of floor space and/or by the lack of additional clearance to the ceiling necessitated by the fact that the wardrobe will require a greater ceiling height while being raised from a laying position to a standing position compared to the ceiling height required once standing.

WO 2018/004416 A1 there is disclosed a furniture module in which these problems are addressed. There is disclosed a furniture module comprising two opposing side walls which are interconnected via a back-piece which is pre-mounted to the two side walls. The back-piece is foldable relative to the two side walls and/or is formed of at least two portions that are foldable relative to each other.

However, as will be apparent, there is still room for improvements when it comes to facilitating assembly and still providing a strong furniture module.

### SUMMARY OF INVENTION

It is an object of the invention to provide a furniture module which is strong, and which is easy to assemble.

This object has been achieved by a furniture module comprising
two opposing side walls being interconnected by a rear wall panel arrangement,
a shelf configured to be positioned between the side walls, preferably between a respective top portion of the side walls,
wherein the shelf is provided with a front dowel on each side of the shelf and a central dowel on each side of the shelf,
wherein the front dowel on each side of the shelf extends a first distance from the respective side of the shelf to a respective free end of the respective dowel and the central dowel extends on each side of the shelf a second distance from the respective side of the shelf to a respective free end of the respective dowel, wherein the first distance is greater than the second distance. The front dowel and the central dowel are each configured to be inserted into associated front and central recesses of a respective portion of the side walls.

This design makes it possible to make good use of the space provided between the opposing side walls when they are in the shelf installation position in which front portions of the side walls are at a greater horizontal distance from each other than a horizontal distance between rear portions of the side walls. The front dowels may be relatively long and thereby provide a strong connection to the side walls without the central dowels forcing the side walls too much apart. The first distances by which the front dowels extend from each side of the shelf may preferably be related to the second distances by which the central dowels extend from each side of the shelf in relation to respective distance from the rear wall panel arrangement such the front dowel and the central dowel both abut and slide against the respective inwardly facing major surface.

It may be noted that the shelf may, especially when installed between a respective top portion of side walls, also be referred to as a top or top panel of the furniture module, such as a top or top panel of a wardrobe. If there is space above the furniture module, the top panel may in a sense also be used as a shelf allowing items to be stored on top of the furniture module. If the shelf is installed at a lower portion of the furniture module it may also be referred to as a bottom or bottom panel.

Preferred embodiments appear in the dependent claims and in the description.

In one embodiment, the front dowel and the central dowel are each configured to be inserted into associated front and central recesses of a respective top portion of the side walls.

The rear wall panel arrangement is preferably flexible. In this context, flexible preferably refers to a rear wall panel arrangement being configured to allow the two opposing side walls to be folded relative to each other and to assume a flat-laid state.

Preferably, each of the opposing side walls comprises a front recess and a central recess which are formed on an inwardly facing major surface facing the opposing side wall and which are positioned in a front portion, respectively a central portion of the respective side wall, preferably in a front top portion respectively a central top portion of the respective side wall.

Preferably, the front recess and the central recesses each comprises an insertion portion and a locking portion extending from the insertion portion in a shelf sliding direction.

The rear wall panel arrangement is preferably configured to allow the opposing side walls to assume a shelf installation position in which front portions of the side walls are at a greater horizontal distance from each other than a horizontal distance between rear portions of the side walls thereby allowing the shelf to be inserted by a movement at least partly along the shelf sliding direction until the dowels reaches the respective associated recess and, after the respective dowel has been inserted into the insertion portion of the respective recess, be further moved along the shelf sliding direction such that the respective dowel is transferred into the locking portion of the respective recess.

Since the front recesses and the central recesses each comprises an insertion portion and a locking portion extending from the insertion portion in a shelf sliding direction, in combination with the flexible rear wall panel arrangement being configured to allow the opposing side walls to assume a shelf installation position in which front portions of the side walls are at a greater horizontal distance from each other than a horizontal distance between rear portions of the side walls, the shelf may be inserted by a movement along the shelf sliding direction until the dowels reaches the respective associated recess and, after the respective dowel has been inserted into the insertion portion of the respective recess, be further moved along the shelf sliding direction such that the respective dowel is transferred into the locking portion of the respective recess. This allows for installation of the furniture module also in places where there is no space at all present above the furniture module. Moreover, by the flexible rear wall panel arrangement being configured to allow the opposing side walls to assume a shelf installation position in which front portions of the side walls are at a greater horizontal distance from each other than a horizontal distance between rear portions of the side walls, the shelf may be inserted between the opposing side walls and be pushed rearwardly. This rearward movement of the shelf may be used to provide or further widen the slight outwardly flared position of the side walls in the installation position. This provision the flared position or further widening of the flared position may be against a resilience of the already partly assembled furniture module, i.e., against an inherent tension of the partly assembled furniture module to move the opposing side walls inwardly from the installation position towards an intended final position. This resilience may be used to more or less automatically insert the respective dowel into the insertion portion of the respective recess, by the side walls due to the resilience automatically moving towards each other when the dowels, during the insertion movement of the shelf, reaches the respective associated recess. Thereby, there is no need to actively push the respective side wall inwardly to provide the desired insertion of the respective dowel into the respective recess. Thus, the conceptual design of the furniture module makes it possible install the furniture module without requiring any additional space above the furniture module. Moreover, the conceptual design makes it possible to actually design the furniture such that it becomes resilient resulting in an automatic insertion of the respective dowel into the respective recess.

A portion which is given both a label related to a horizontal position, e.g., with any one of the labels front/central/rear, and a label related to a vertical position, e.g., with any one of the labels top, central, lower, refers to a portion limited both vertically and horizontally based on said labels. The front lower corner portion e.g., preferably refers to a portion at the front lower corner and within a distance as measured in any direction from the front lower corner, the distance being about 25% of a distance from the front lower corner to the rear lower corner of the respective side wall. This preferably applies also for the other portions given both the label related to a horizontal position and a label related to a vertical position. When it comes to a portion denoted as central along horizontal, irrespectively of it is part of a single or double label, this preferably refers to a portion having a horizontal extension being about 25% of a shortest distance from the front to the rear of the respective side wall and being located centred about a substantially vertical centre line between the front and the rear. Thus, a portion only referred to as central in the context of a horizontal position, preferably refers to a vertically extending portion being centred about a centre line between the front and the rear and having extension being about 25% of a shortest distance from the front to the rear of the respective side wall. A portion referred to as central and also being labelled with top or lower is preferably also limited from the top, or the bottom, respectively, such that the portion along vertical have extension being about 25% of a shortest distance from the front to the rear. It may also be noted that the labels may be directly associated to a respective entity or may be derived by labels associated with a base entity or with a second entity with which the first entity interacts. For instance, a central dowel on a shelf which preferably is located between a respective top portion of the side walls may in a sense be said to be in a portion having the derived labels central in the horizontal direction and top in the vertical direction, i.e., it may be referred also to as a central top portion of the furniture module.

In a preferred embodiment, the respective insertion portion of each recess has an insertion portion width as measured in a direction being transverse to a depth direction and being transverse to the shelf sliding direction.

The respective first locking portion and the respective second locking portion of each recess may each have opposing recess side walls, which faces each other and which preferably each has an extension along the depth direction and along the shelf sliding direction.

The opposing recess side walls may be provided with one or more opposing ridges. Each ridge preferably has a longitudinal extension along the shelf sliding direction and a height extending from the respective recess side wall towards the opposing ridge of the opposing recess side wall.

The opposing recess side walls may each be provided with at least one set of opposing valleys located at a valley depth, the valley depth being greater than the ridge depth,

Preferably a locking portion width formed by a shortest distance between opposing ridges is smaller than the insertion portion width and is smaller than a shortest distance between opposing valleys

In a preferred embodiment, each dowel comprises, as seen along a longitudinal extension of the respective dowel extending from the respective side of the shelf to a respective free end of the respective dowel, a stem having a stem width followed by at least one dowel ridge. The dowel ridge preferably has an extension in a radial direction of the respective dowel and extending along at least a portion of a circumference of the respective dowel. Followed is intended to refer to the fact that the at least one dowel ridge is positioned at a greater distance from the respective side of the shelf. It may in this context be noted that in case the respective dowel is provided with more than one dowel ridge, the portion between the two dowel ridges may also be referred to as a valley. In the disclosed embodiment, the front dowels each comprises as seen along the longitudinal extension of the respective dowel a first stem or valley, a first ridge, a second stem or valley, and a second ridge close to the free end of the dowel. In the preferred embodiment, the respective central dowel comprises a stem and a ridge.

It is preferred that the stems or valleys respectively the ridges of the front and central dowels and the front and central recess have the same rounded triangular shape and size and that the difference in length of the front dowels and the central dowels and the corresponding difference in depth of the recesses is provided by having different number of ridges and valleys. This facilitates manufacture.

The stem of the respective dowel is configured to pass between two opposing ridges of the respective recess when the respective dowel is transferred from the respective insertion portion to the respective locking portion such that the respective dowel ridge now being located at a greater depth becomes caught beneath the two opposing ridges of the respective recess.

The furniture module may further comprise at least one shelf locking member each having a body part configured to be attached to a side wall and a dowel connected to the respective body part, the dowel being configured to interact with a recess formed in a downwardly facing major surface of the shelf and thereby prevents the shelf from being removed from the intended installed position of the shelf. By providing a locking member accidental removal of the shelf is prevented, or at least counter-acted.

The dowel is preferably movably connected to the respective body part and is movable between a shelf insertion position, in which the shelf is insertable between the side walls to an intended installed position of the shelf, and a shelf locking position in which the dowel interacts with a recess formed in a downwardly facing major surface of the shelf and thereby prevents the shelf from being removed from the intended installed position of the shelf. The shelf locking member may be designed such that the dowel is to be moved from the shelf insertion position to the shelf locking position by an active action of the installer. The shelf locking member may be designed such that the dowel is automatically moved from the shelf insertion position to the shelf locking position when the shelf reaches its intended installed position. This latter may e.g., be accomplished by providing a resilient connection between the dowel and the body part.

Preferably, the furniture module comprises at least two shelf locking members each being configured to be attached to a respective one of the two opposing side walls.

The furniture module may further comprise
a first member configured to be attached to at least one of the sidewalls, and
a second member being configured to be attached to at least one of the side walls, preferably to both opposing side walls,
wherein the respective side wall comprises a first recess,
wherein the first recess comprises an insertion portion, a first locking portion extending from the insertion portion in a first direction, and a second locking portion extending from the insertion portion in a second direction, the second direction being different from the first direction, and
wherein the first recess is configured to receive a first dowel of the first member and a first dowel of the second member,
wherein a projected distance, as measured along the first direction, between the first locking portion and the second locking portion is such that, when installed, the first member is by the second member prevented from being released by a movement in a direction opposite to the first direction.

Also, the first member may be basically any part of a furniture. The first member may e.g., be a height adjustment member arranged at a rear lower corner of the furniture module. The first member may e.g., be a piece of furniture extending between two opposing sides of the furniture module, such as extending between two opposing side walls of the furniture module. Thus, the first member may e.g., be a bottom shelf, a central shelf or a top shelf of the furniture module. It may also be noted that the furniture member may be provided with one or more recesses formed with one insertion portion and two locking portions in combination with one or more recesses formed with one insertion portion and one locking portion. It is e.g., conceivable that a shelf, such as a shelf forming a bottom or top of a wardrobe, is connected to the side wall by a rear and/or central dowel being inserted into a respective recess having only one locking portion and where a front dowel is inserted into a recess having two locking portions where the second locking portion is configured to receive a first dowel of a front frame member such that the front frame member abuts the shelf and prevents the shelf from being removed. In such a case, the front frame member may similarly also have a second dowel being configured to be received in another recess also having one insertion portion and one locking portion.

In the following the invention will mostly be discussed with reference to a preferred embodiment in which there is provided two furniture members forming two opposing side walls, which furniture members preferably are interconnected by a rear wall panel arrangement, two first members forming first and second height adjustment members configured to be attached to a respective opposing side wall at a front lower corner portion of the respective side wall on an inwardly facing major surface of the respective side wall facing the opposing side wall, and the second member forming a lower front frame member being configured to be attached to both opposing side walls, at the respective front lower corner portion of the respective side wall on an inwardly facing major surface of the respective side wall facing the opposing side wall, and thereby interconnect the two opposing side walls at a front lower portion of the furniture module.

Preferably, respective side wall further comprises a second recess, wherein the respective first recess on the respective side wall panel is positioned at a first height and the respective second recess on the respective side wall panel is positioned at a second height, wherein the first height is preferably greater than the second height.

Preferably, the recesses are positioned such that a projection of the respective first recess onto a horizontal plane at least partly overlaps with a projection of the respective second recess onto the horizontal plane.

More preferably, the recesses are positioned such that a geometrical line extending from a centre point of the respective insertion portion of the respective first recess to a centre point of the respective an insertion portion of the respective second recess extends substantially vertically downwardly.

By having the recesses on different heights, it is possible to make use of forces arising due to gravity to keep the height adjustment members and/or lower front frame member in the intended position. This effect is further improved if there is a horizontal overlap and is even further improved if the recesses are more or less positioned one above the other.

Preferably, the first direction is substantially horizontal, and the second direction is different from the respective first direction. Thereby, it is possible to install the height adjustment members in a state in which they have a pre-set length basically corresponding to an intended non-adjusted position. This makes it possible to design the height adjustment members with a comparably limited adjustment stroke length, since the complete adjustment stroke length may be used to actually provide an adjustment of the height adjustment member.

Alternatively, or as a complement thereto, preferably, the second direction is substantially vertical, and the first direction is different from the respective second direction. This makes it possible to make use of forces arising due to gravity to keep the lower front frame member in the intended position. Moreover, since the lower front frame member may be kept in the intended position with the aid of gravity, the height adjustment member also connected to the same recesses may in turn be kept in the intended position with the aid of the lower frame member.

Preferably, the first direction is substantially horizontal, and the second direction is substantially vertical.

It may be noted that, although, in the preferred embodiment, the first direction is substantially horizontal, and wherein the second direction is substantially vertical, other combinations of directions are also conceivable. The second direction may e.g., be substantially vertical in combination with the first direction being different from the second direction and also different from horizontal. The first direction may e.g., extend from the insertion portion inclined upwardly and rearwardly. It may also be noted that, although, in the preferred embodiment the first direction of the first recess is parallel to the first direction of the second recess, it is conceivable that the two directions are different from each other. It is e.g., conceivable that the first direction of the first recess, the upper one of the two recesses, extends inclined upwardly and rearwardly in combination with the first direction of the second recess, the lower one, extends horizontally, or at least more horizontally. It may also be noted that the first direction may e.g., be substantially horizontal in combination with the second direction being different from the first direction and also different from vertical. The second direction may e.g., be inclined downwardly and rearwardly such that the lower front frame member is moved rearwardly towards the respective height adjustment member when the lower front frame member is installed.

Preferably, the furniture module comprises two first members forming a first and a second height adjustment members configured to be attached to a respective opposing side wall at a front lower corner portion of the respective side wall on an inwardly facing major surface of the respective side wall facing the opposing side wall.

The furniture module may further be configured such that the second member forms a lower front frame member being configured to be attached to both opposing side walls, at the respective front lower corner portion of the respective side wall on an inwardly facing major surface of the respective side wall facing the opposing side wall, and thereby interconnect the two opposing side walls at a front lower portion of the furniture module.

Each of the opposing side walls may comprise a first and a second recess which are formed on an inwardly facing major surface facing the opposing side wall and which are positioned in the front lower corner portion of the respective side wall.

The respective recess at the front lower corner portions may each comprise an insertion portion, a first locking portion extending from the insertion portion in a respective first direction, and a second locking portion extending from the insertion portion in a respective second direction, the respective second direction being different from the respective first direction.

At the front lower corner portion of the respective side wall panel, the first recess of the first side wall may be configured to receive a first dowel of the first height adjustment member and a first dowel on a first side of the lower front frame member, the second recess of the first side wall may be configured to receive a second dowel of the first height adjustment member and a second dowel on a first side of the lower front frame member, the first recess of the second side wall may be configured to receive a first dowel of the second height adjustment member and a first dowel on a second side of the lower front frame member, and the second recess of the second side wall may be configured to receive a second dowel of the second height adjustment member and a second dowel on a second side of the lower front frame member.

By the recesses being designed such that they each are provided with an insertion portion, a first locking portion extending from the insertion portion in a respective first direction, and a second locking portion extending from the insertion portion in a respective second direction, the respective second direction being different from the respective first direction, it is facilitated to provide a compact design with the lower front frame member and the a first and second height adjustment members being positioned close to each other and still performing the machining operation, such as milling operation, to provide the recesses in a single operation. The manufacturing may e.g., be performed by allowing a milling tool to form the insertion portion and then moving the milling tool to form the first locking portion followed by moving the milling tool to form the second locking portion, whereafter the milling tool is returned to the insertion portion and removed from the respective recess. Preferably the milling tool have along a depth direction of the recess profile similar to the profile of the dowel intended to be inserted into the recess. By the recesses being designed such that they each are provided with an insertion portion, a first locking portion extending from the insertion portion in a respective first direction, and a second locking portion extending from the insertion portion in a respective second direction, the respective second direction being different from the respective first direction, it is facilitated to provide an interlocking functionality in the sense that the height adjustment members may automatically be kept in the intended position by the fact that the lower front frame member connected to the recesses thereafter may be used to prevent the height adjustment members from being removed from the respective recesses. This possibility to provide an interlocking functionality in turn may be used to provide the first direction in a direction which is beneficial from a load bearing perspective and a height adjustment perspective, but which direction might not be really beneficial from the perspective of keeping the height adjustment members from being removed from the respective recesses. In the preferred embodiment this is used to provide the first direction in a mainly horizontal direction.

With the design described above, it is convenient for the installer to simply put the height adjustment members in the intended position and thereafter simply install the lower front frame member such that a strong interconnection of the two opposing side walls is accomplished at a front lower portion of the furniture module.

The dowels of the lower front frame member may be configured to be inserted into the insertion portions of the first respectively the second recess at the respective front lower corner portion and to be transferred to the first locking portion of the respective recess.

In a preferred embodiment, the dowels of the respective height adjustment member are be configured to be inserted into the insertion portion of the respective recess and to be transferred to the first locking portion of the respective recess before the dowels of the lower front frame member are configured to be inserted into the insertion portion of the respective recess and to be transferred to the second locking portion of the respective recess.

A projected distance, as measured along the first direction, between the first locking portion and second locking portion may be such that, when installed, the respective height adjustment member abuts the lower front frame member whereby the respective height adjustment member is by the lower front frame member prevented from being released by a movement in a direction opposite to the first direction. To achieved this, the projected distance between the first locking portion and the second locking portion is preferably related to the physical design of the first and second members such that the first and second members together occupies at least a fraction of this projected distance such that the first member will come into contact with the second member before the first member reaches the insertion potion. Preferably the first and second members together occupies the full projected distance such that they abut each other already when the dowels of the respective member are in the first respectively second locking portion. It may be noted that the projected distance between the first and second locking portions may be on a first position along the second direction and the first and second members may come into contact with, or abut, each other at a second position along the second direction being different from the first position. It may in this context also be noted that the interface between the first and second members preferably is such that the first and second members may slide along each other allowing the second member to be moved along the second direction while being in contact with the first member.

In this sense “abuts” may refer to the height adjustment member and the lower front frame member exerting a force on to each other along respectively in oppositely the first direction. With such a design, the respective height adjustment member is kept in the respective intended position since any movement of the height adjustment members is prevented as long as the lower front frame member is kept in its intended position. This is preferably combined with the fact that the second direction is substantially vertical.

In a preferred embodiment, the respective insertion portion of each recess has an insertion portion width as measured in a direction being transverse to a depth direction and as measured transverse to the first direction and as measured transverse to the second direction.

The respective first locking portion and the respective second locking portion of each recess may each have opposing side walls, which faces each other and which each has an extension along the depth direction and along the first respectively the second direction.

Each of the opposing side walls may be provided with
at least one ridge with each ridge being located at a ridge depth, as seen along the depth direction, and having a longitudinal extension along the shelf sliding direction and a height extending from the respective side wall towards an opposing ridge of the opposing side wall, and
at least one valley located at a valley depth, the valley depth being greater than the ridge depth.

A locking portion width formed by a shortest distance between opposing ridges may be smaller than the insertion portion width and is smaller than a shortest distance between opposing valleys.

With this design, there is provided a strong interconnection between on one hand the dowels of the first and a second height adjustment members and the dowels of the lower front frame member and on the other hand the recesses in turn providing a strong furniture module. The ridges and valleys prevent the dowels of the first and a second height adjustment members and the dowels of the lower front frame member from being pulled out of the recesses.

In a preferred embodiment, each dowel of the first and a second height adjustment members and/or each dowel of the lower front frame member comprises, as seen along a longitudinal extension of the respective dowel extending from the respective height adjustment member respectively the lower front frame member to a respective free end of the respective dowel, a stem having a stem width followed by a least one dowel ridge, the dowel ridge having an extension in a radial direction of the respective dowel and extending along at least a portion of a circumference of the respective dowel.

It may in this context be noted that all the recesses configured to receive the dowels of the various parts preferably have a depth being less than the material thickness in the part in which they are formed, i.e., the recesses are preferably not visible on the surface being opposite the surface in which the respective recess is formed.

The above-mentioned object has also been achieved by a method of attaching a shelf between two opposing side walls of a furniture module, the two opposing side walls being interconnected by a rear wall panel arrangement, preferably a flexible rear wall panel arrangement, the method comprising:
attaching a shelf between the two opposing side walls, preferably between a respective top portion of the respective side wall, by the rear wall panel arrangement allowing the opposing side walls to assume a shelf installation position in which front portions of the side walls are at a greater horizontal distance from each other than a horizontal distance between rear portions of the side walls and by moving the shelf along a shelf sliding direction until a front dowel on each side of the shelf and a central dowel on each side of the shelf reaches a respective associated recess and, after the respective dowel has been inserted into an insertion portion of the respective recess, be further moved along the shelf sliding direction such that the respective dowel is transferred into a locking portion of the respective recess.

The advantages achieved by the various features have been explained above with reference to a furniture module, and those advantages are equally applicable to the method. Also preferred embodiments of the various components and features discussed with reference to the furniture module are equally applicable in respect of the method.

The method may further comprise
attaching a first and a second height adjustment members at a front lower corner portion of the respective side wall on an inwardly facing major surface of the respective side wall facing the opposing side wall by inserting a first and a second dowel of the respective height adjustment member into an insertion portion of a first and a second recess formed in the respective front lower corner potion of the respective side wall and sliding the respective height adjustment member in a first direction such that the dowels of the respective height adjustment member are transferred to a respective first locking portion of the respective recess, and
attaching the lower front frame member to both opposing side walls by inserting a first and a second dowel on a first side of the lower front frame member and a first and a second dowel on a second side of the lower front frame member into the respective insertion portion of the first and second recesses formed in the respective front lower corner potion of the respective side wall and sliding the lower front frame member in a second direction, the second direction being different from the first direction,) such that the dowels of the lower front frame member are transferred to a respective second locking portion of the respective recess,
wherein preferably the actions of attaching a first and a second height adjustment members and of attaching the lower front frame member to both opposing side walls is performed before the action of attaching a shelf between the two opposing side walls.

By attaching the first and second height adjustment members and attaching the lower front frame member to both opposing side walls, the intended distance between the side walls at the front lower portion is maintained when the shelf is to be installed. This is advantageous since the maintained distance between the side walls the front lower portion results in that the dowels on the shelf forces the top portions of the side walls apart, which in turn results in that the side walls will move towards each other when the dowels of the shelf reach the associated recesses of the side walls and thereby the dowels will be inserted into the associated recesses.

Preferably, the action of sliding the respective height adjustment member in a first direction involves sliding the respective height adjustment member in a substantially horizontal direction.

Preferably, the action of sliding the lower front frame member in a second direction involves sliding the lower front frame member in a substantially vertical direction.

Preferably, the action of sliding the respective height adjustment member in a first direction is performed before the action of sliding the lower front frame member in a second direction. This order is especially advantageous in case the action of sliding the respective height adjustment member in a first direction involves sliding the respective height adjustment member in a substantially horizontal direction, and the action of sliding the lower front frame member in a second direction involves sliding the lower front frame member in a substantially vertical direction.

The method may further comprise; the respective height adjustment member abutting the lower front frame member when the respective height adjustment member and the lower front frame member has been attached to the respective front lower corner potion of the respective side wall whereby the respective height adjustment member is by the lower front frame member prevented from being released by a movement in a direction opposite to the first direction.

It may be noted that the use of first, second, third, fourth, fifth, etc. are mainly to be seen as labels facilitating reading and that it does not necessarily mean that there need to be all the intervening numbers of entities present. However, to facilitate reading, we have consistently used the numbering first, second, third, fourth, etc., as labels, and in a sense based on an embodiment including all conceivable entities.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Additionally, variations to the disclosed embodiments can be understood and effected by the skilled person in practicing the claimed 30 invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

### BRIEF DESCRIPTION OF THE DRAWINGS

The invention will by way of example be described in more detail with reference to the appended schematic drawings, which shows a presently preferred embodiment of the invention.

FIG. 1 disclose a furniture module comprising two opposing side walls being interconnected by a flexible rear wall panel arrangement.

FIG. 2a discloses installation of height adjustment members at the front and FIGS. 2b and 2c disclose in more detail a first and a second step in the installation of a height adjustment member.

FIGS. 3a-b disclose installation of a lower front frame member.

FIGS. 4a-b disclose in more details the design of the dowels of the lower front frame member and the height adjustment members, respectively.

FIGS. 5a-b disclose some geometrical relationships between the recesses and the different portions of the respective recess.

FIGS. 6a-c disclose installation of height adjustment members at the rear.

FIGS. 7a-b discloses installation of a lower rear frame member.

FIGS. 8a-c discloses design and installation of shelf locking members.

FIGS. 9a-e discloses installation of a shelf.

FIGS. 10a-c discloses details of the shelf.

FIG. 11 discloses details of the shelf and the opposing side walls related to the installation of the shelf.

FIGS. 12a-b discloses interaction of the shelf locking member and the shelf.

### DETAILED DESCRIPTION OF PREFERRED EMBODIMENTS

In the following, the installation of the furniture module 1 will be shortly described.

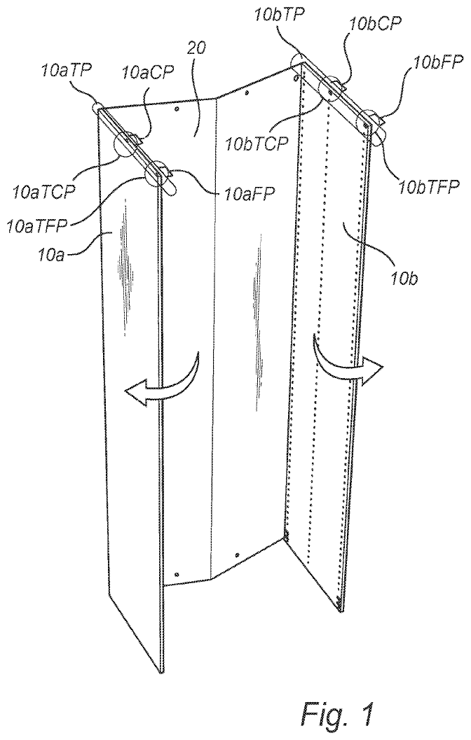

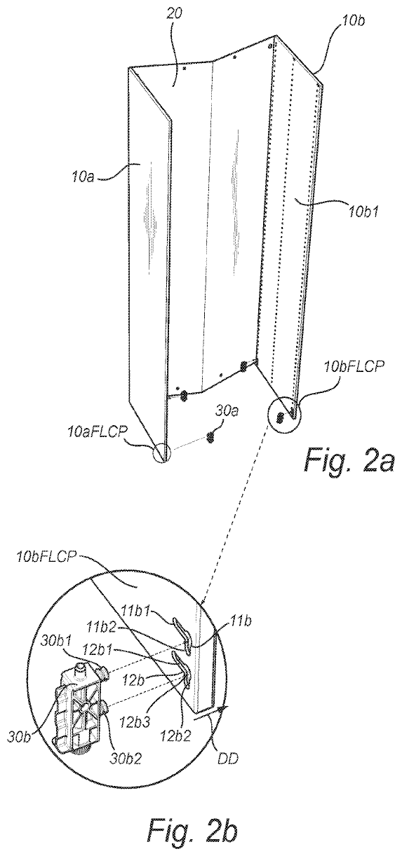

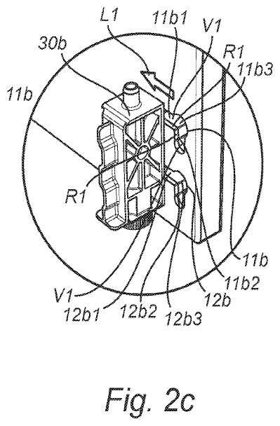

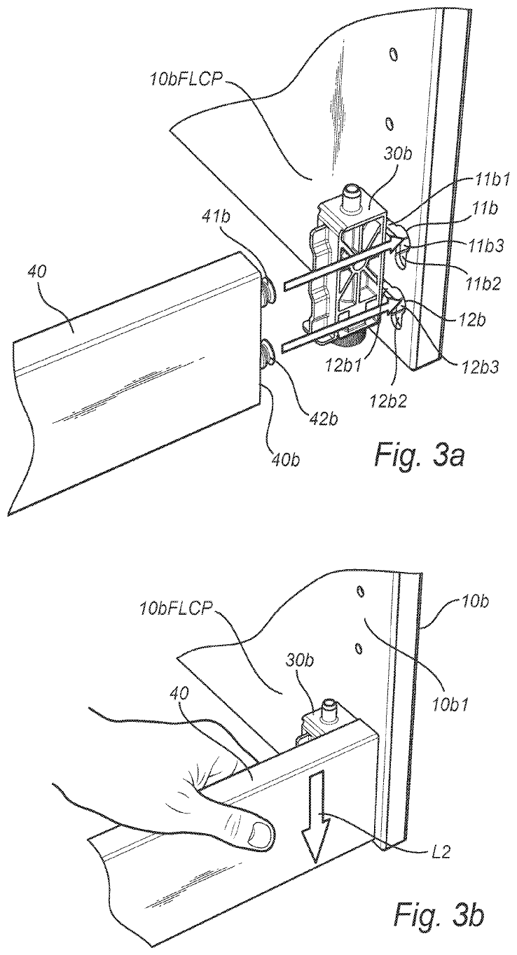

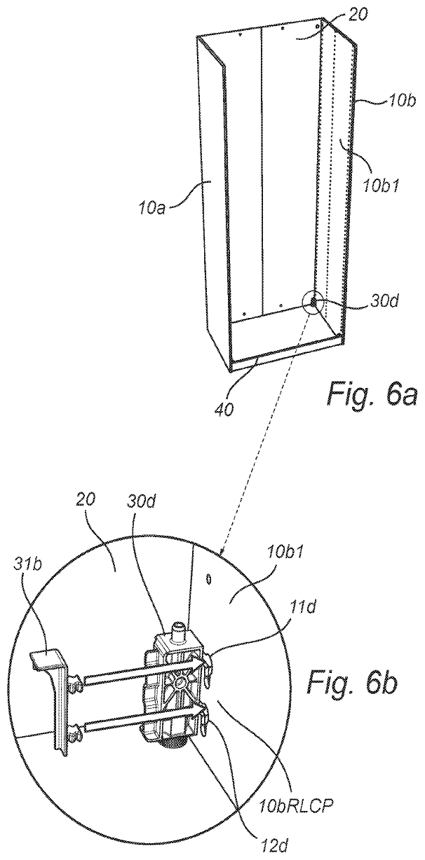

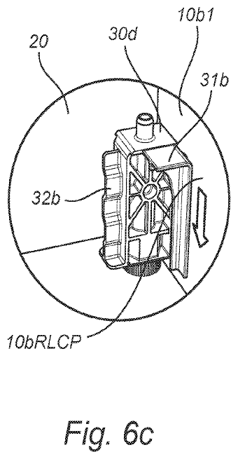

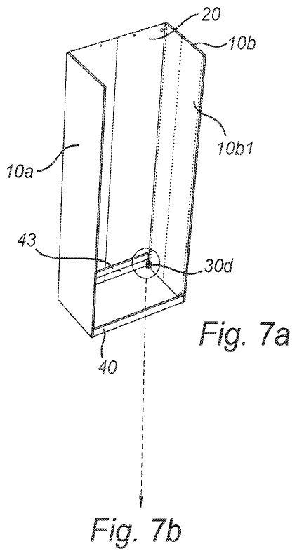

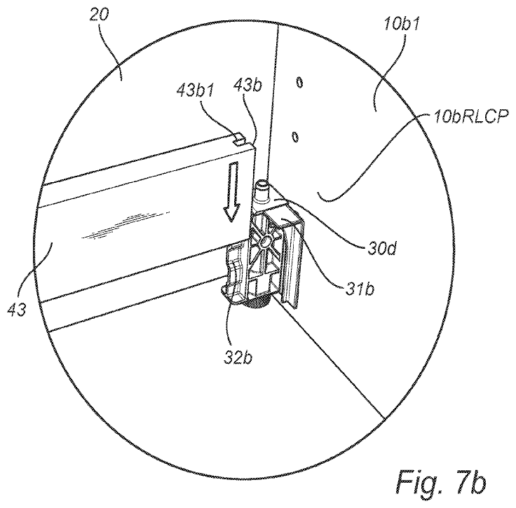

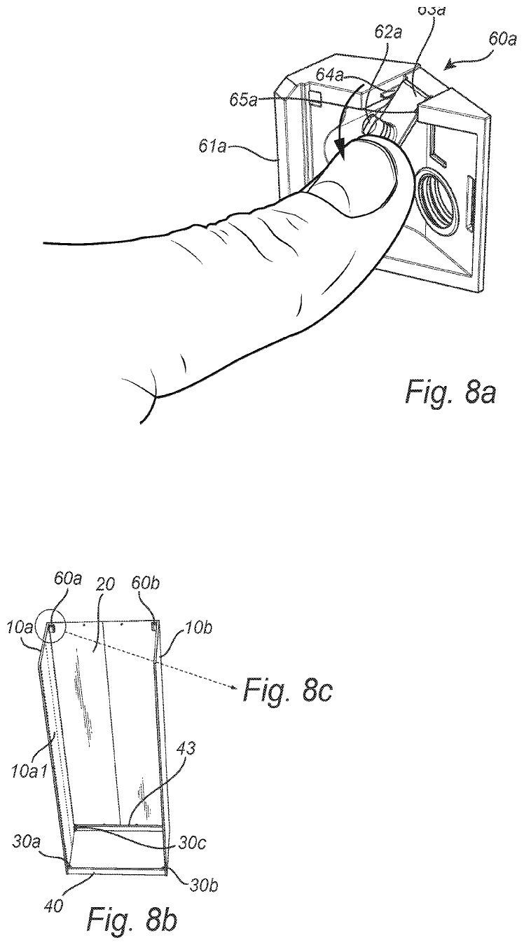

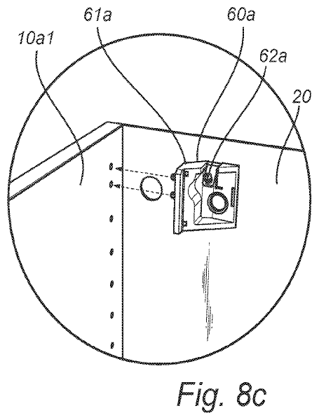

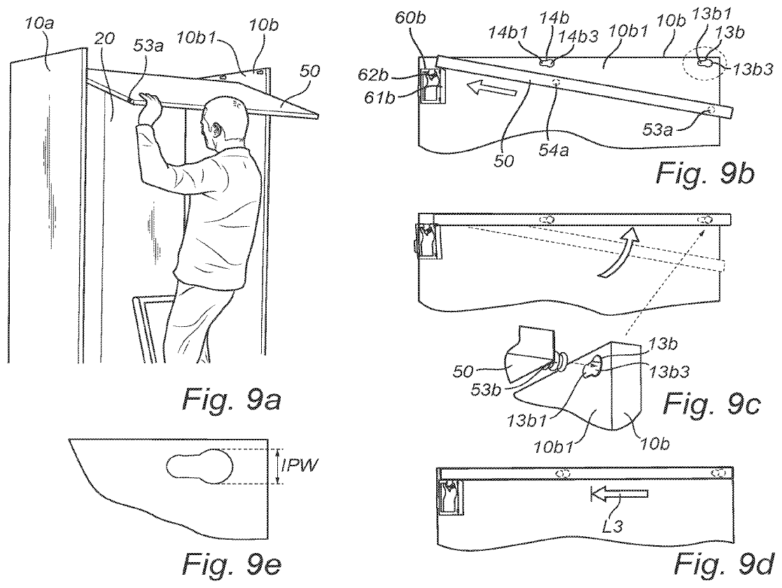

As illustrated in FIG. 1, the installation of the furniture module 1 is initiated by connecting side walls 10a-b to a flexible rear wall panel arrangement 20. Then, as seen in FIG. 2b-c, the installation of a first and a second height adjustment members 30a-b to the front lower corners 10aFLCP, 10bFLCP of each of the side walls 10a-b may be initiated. As demonstrated in FIG. 3a-b, upon having installed the first and the second height adjustment members 30a-b, a lower front frame member 40 may be installed whereby the side walls 10a-b may be connected through the lower front frame member 40. FIG. 6a illustrates the installation of a third and a fourth height adjustment members 30c-d to the rear lower corner portions 10aRLCP, 10bRLCP of the side walls. The installation of a lower rear frame member 43 may be realized in accordance with FIG. 7a-b. Lastly, the installation of a shelf may be realized by positioning the shelf between the side walls 10a-b, as seen in FIGS. 8a-9d.

The installation of the first height adjustment member 30a is realized by inserting a first and a second dowel 30a1, 30a2 of the first height adjustment member 30a into a first and second recess 11a, 12a, respectively, of the front lower corner portion 10aFLCP of the first side wall 10a. Similarly, the second height adjustment member 30b is realized by inserting a first and a second dowel 30b1, 30b2 of the second height adjustment member 30b into a first and second recess 11b, 12b, respectively, of the front lower corner portion 10bFLCP of the second side wall 10b. The height adjustment members 30a-b are secured to a respective side wall 10a-b by their respective dowels 30a1, 30a2, 30b1, 30b2 being firmly fitted inside their respective recesses 11a, 12a, 11b, 12b. The height adjustment members 30a-b are abutting the side walls 10a, 10b respectively, and the surface on which the furniture module 1 is supported on, in the intended use of the furniture module 1. Additionally, when the lower front member 40 is installed, the height adjusting members 30a-b abut the lower front member 40 thereby making the height adjustment members 30a-b substantially immovable. By installing the first and the second height adjustment members 30a-b to the front lower corners 10aFLCP, 10bFLCP of each of the side walls 10a-b, the furniture module 1 may accommodate surfaces with varying topological characteristics by adjusting the first and second height adjustment members 30a-b.

The installation of the lower front frame member 40 is realized by, firstly, inserting a first dowel and a second dowel 41a, 42a on a first side 40a of the lower front frame member 40 into a first and a second recess 11a-b, respectively. Secondly, the installation is further realized by inserting a first dowel and a second dowel 41b, 42b on a second side 40b of the lower front frame member 40 into a first and a second recess 12a-b, respectively. The lower front frame member 40 abuts the surface on which the furniture module is supported, in the intended use of the furniture module. The dowels 41a, 42a, 41b, 42b of the lower front frame member 40 are secured in their respective recesses 11a-b, 12a-b such that the front lower corner portions 10aFLCP, 10bFLCP of the side walls 10a-b are being fixed at a distance from each other hence making front lower corner portions 10aFLCP, 10bFLCP of the side walls 10a-b substantially immovable.

The installation of the third height adjustment member 30c is realized by inserting a first and a second dowel 30c1, 30c2 of the third height adjustment member 30c into a third and fourth recess 11c, 12c, respectively, of the rear lower corner portion 10aRLCP of the first side wall 10a. Similarly, the installation of the fourth height adjustment member 30d is realized by inserting a first and a second dowel 30d1, 30d2 of the fourth height adjustment member 30d into a third and fourth recess 11d, 12d, respectively, of the front lower corner portion 10bFLCP of the second side wall 10b. The installation of the third and fourth height adjustment members 30c, 30d is best seen in FIGS. 6a-c. The height adjustment members 30c-d are secured to a respective side wall 10a-b by their respective dowels 30c1, 30c2, 30d1, 30d2 being firmly fitted inside their respective recesses 11c, 12c, 11d, 12d. The height adjustment members 30c-d are abutting the side walls 10a, 10b respectively, and the surface on which the furniture module 1 is supported on, in the intended use of the furniture module 1. Continuing with FIGS. 6a-c, a first blocking member 31a may be configured to be inserted into the third and fourth recess 11c, 12c. When the first blocking member 31a has been received by the third and fourth recess 11c, 12c, the height adjusting member 30c abuts the first blocking member 31a thereby making the height adjustment member 30c substantially immovable. Analogously, a second blocking member 31b is configured to be inserted into the third and fourth recess 11d, 12d. When the first blocking member 31b has been received by the third and fourth recess 11d, 12d the height adjusting member 30d abuts the second blocking member 31b thereby making the height adjustment member 30d substantially immovable. By installing the third and the fourth height adjustment members 30c-d to the rear lower corners 10aRLCP 10bRLCP of each of the side walls 10a-b, the furniture module 1 is given further possibilities of accommodating surfaces with varying topological characteristics by adjusting the third and fourth height adjustment members 30c-d.

The installation of the lower rear frame member 43 is realized by, firstly, connecting a first slit 43a1 of a first side 43a of the lower rear frame member 43 to a first track 32a of the third height adjusting member 30c. Secondly, the installation of the lower rear frame member 43 is further realized by connecting a second slit 43b1 of a second side 43b of the lower rear frame member 43 to a second track 32b of the fourth height adjusting member 30d. The installation of the lower rear frame member 43 is best seen in FIGS. 7a-b. By connecting the first and second slits 43a1, 43b1 of the lower rear member 43 to their associated tracks 32a, 32b of the height adjustment members 30c-d, the rear lower corners 10aRLCP, 10bRLCP of each of the side walls 10a-b are secured at a fixed distance from each other hence making the rear lower corner portions 10aFLCP, 10bFLCP of the side walls 10a-b substantially immovable relative to each other.

The installation of the shelf 50 is realized by inserting a front dowel 53a-b on each side 50a-b of the shelf 50 and a central dowel 54a-b on each side 50a-b of the shelf into their associated front and central recesses 13a-b, 14a-b, of a respective top portion of the side walls 10a-b. Alternatively, the front dowel 53a-b and the central dowel 54a-b are each configured to be inserted into an associated front and central recesses 13a-b, 14a-b of a respective portion of the side walls 10a-b. The associated front and central recesses 13a-b, 14a-b may be arranged on a top portion, a mid portion, or a lower portion of the side walls 10a-b. Hence, the front and central recesses 13a-b, 14a-b may be arranged anywhere along a vertical extension of the side walls 10a-b. Additionally, at least one shelf locking member 60a-b is configured to be attached to a side wall 10a-b. The shelf locking member 60a-b comprises a dowel 53a-b which may be inserted to a recess 55a-b formed in a downwardly facing major surface 501 of the shelf 50. This arrangement fixes the shelf 50 in an intended installed position. Further, in the intended installed position of the shelf 50, each side 50a-b of the shelf 50 abuts a respective top portion of the side wall 10a-b hence keeping the distance between a said respective top portion of the side walls 10a-b fixed.

As can be seen in FIG. 1, two opposing side walls 10a-b are being interconnected by a flexible rear wall panel arrangement 20. It is preferred that a longitudinally extending edge of each of the two opposing side walls 10a-b are connected to a respective longitudinally extending edge of the flexible rear wall panel arrangement 20. Each of the two opposing side walls 10a-b may be connected to the flexible rear wall panel arrangement 20 by means of e.g., screws, nails, adhesives, bolts, a snap-fit mechanism, or any other equivalent means normally used in the art.

Turning to FIG. 2a, a first and a second height adjustment members 30a-b are configured to be attached to a respective opposing side wall 10b, 10a at a front lower corner portion 10aFLCP, 10bFLCP of the respective side wall 10a-b. The front lower corner portions 10aFLCP, 10bFLCP are located on an inwardly facing major surface 10a1, 10b1 of the respective side wall 10a-b facing the opposing side wall 10b, 10a. As seen in FIG. 2b, the first height adjustment member 30a comprises a first dowel 30a1 and a second dowel 30a2. Likewise, the second height adjustment member 30b comprises a first dowel 30b1 and a second dowel 30b2

As is shown in FIG. 2b, each of the opposing side walls 10a-b comprises a first and a second recess 11a-b, 12a-b which are formed on an inwardly facing major surface 10a1, 10b1 facing the opposing side wall 10b, 10a. The first and second recesses 11a-b, 12a-b are positioned in the opposing side wall 10b, 10a at front lower corner portion 10aFLCP, 10bFLCP of the respective side wall 10a-b.

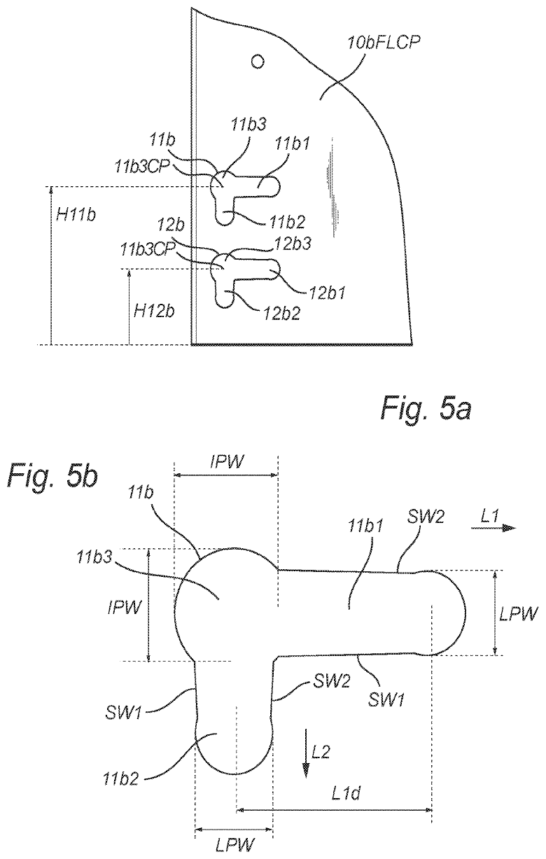

The following describes the portions of each of the respective recess 11a-b, 12a-b. The portions of each of the respective recess 11a-b, 12a-b are best seen in FIG. 5a-b. The respective recess 11a-b, 12a-b at the front lower corner portion 10aFLCP, 10bFLCP each comprises an insertion portion 11a3, 11b3, 12a3, 12b3. The respective recess 11a-b, 12a-b each comprises a first locking portion 11a1, 11b1, 12a1, 12a1 extending from the insertion portion 11a3, 11b3, 12a3, 12a3 in a first direction L1. The respective recess 11a-b, 12a-b each comprises a second locking portion 11a2, 11b2, 12a2, 12b2 extending from the insertion portion 11a3, 11b3, 12a3, 12b3 in a second direction L2. The second direction L2 is different from the first direction L1. The first direction L1 may denote a direction being substantially horizontal. The second direction L2 may denote a direction being substantially vertical. The directions of L1 and L2 are best seen in FIG. 2c.

In the preferred embodiment, the respective first recess 11a-b on the respective side wall panel 10a-b is positioned at a first height H11a-b and the respective second recess 12a-b on the respective side wall panel 10a-b is positioned at a second height H12a-b, wherein the first height H11a-b is preferably greater than the second height (H12a-b).

Preferably, the recesses 11a-b, 12a-b are positioned such that a projection of the respective first recess 11a-b onto a horizontal plane at least partly overlaps with a projection of the respective second recess 12a-b onto the horizontal plane. More preferably, the recesses 11a-b, 12a-b are positioned such that a geometrical line extending from a centre point 11a3CP, 11b3CP of the respective insertion portion 11a3, 11b3 of the respective first recess 11a-b to a centre point 12a3CP, 12b3CP of the respective an insertion portion 12a3, 12b3 of the respective second recess 12a-b extends substantially vertically downwardly. By having the recesses 11a-b, 12a-b on different heights H11a-b, H12a-b it is possible to make use of forces arising due to gravity to keep the height adjustment members 30a-b and/or lower front frame member 40 in the intended position. This effect is further improved if there is a horizontal overlap and is even further improved if the recesses 11a-b, 12a-b are more or less positioned one above the other.

As illustrated in FIG. 2b-c, the first height adjustment member 30a is configured to be attached to a side wall 10a at a front lower corner portion 10aFLCP of the side wall 10a by inserting the first and second dowels 30a1, 30a2 into a first and second recess 11a, 12a of the front lower corner portion 10aFLCP of the first side wall 10a. More specifically, the first and second dowels 30a1, 30a2 are inserted into the insertion points 11a3, 12a3 of the respective recess 11a, 12a. Once the dowels 30a1, 30a2 are positioned inside their associated insertion points 11a3, 12a3, the dowels 30a1, 30a2 are transferred to the first locking portions 11a1, 12a1 of the respective recess 11a, 12a by a sliding movement along the direction L1.

Similarly, the second height adjustment member 30b is configured to be attached to a side wall 10b at a front lower corner portion 10bFLCP of the side wall 10a by inserting the first and second dowels 30b1, 30b2 into a first and second recess 11b, 12b of the front lower corner portion 10bFLCP of the opposing side wall 10b. More specifically, the first and second dowels 30b1, 30b2 are inserted into the insertion points 11b3, 12b3 of the respective recess 11b, 12b. Once the dowels 30b1, 30b2 are positioned inside their associated insertion points 11b3, 12b3, the dowels 30b1, 30b2 are transferred to the first locking portions 11b1, 12b1 of the respective recess 11b, 12b by a sliding movement along the direction L1.

It may be noted that between the insertion portion 11a3, 11b3, 12a3, 12b3 and the first locking portion 11a1, 11b1, 12a1, 12a1 of the respective recess 11a-b, 12a-b, there may be a waist portion having a slightly narrower width. This may be provided to provide a tactile and/or audible feedback to the installer concerning that the height adjustment members 30a-b have reached the intended position. The waist portion may also be designed to provide a retaining force keeping the height adjustment members 30a-b in the intended position such that the height adjustment members 30a-b do not interfere with the insertion of the dowels 41a-b, 42a-b of the lower frame member 40 into the respective recess 11a-b, 12a-b.

FIG. 3a illustrates the lower front frame member 40 being configured to be attached to both opposing side walls 10b, 10a, at a respective front lower corner portion 10aFLCP, 10bFLCP of the respective side wall 10a-b on an inwardly facing major surface 10a1, 10b1 of the respective side wall 10a-b facing the opposing side wall 10b, 10a. This interconnects the two opposing side walls 10a-b at a front lower portion of the furniture module 1. More specifically, the lower front frame member 40 comprises a first and a second dowel 41a, 42a on a first side 40a. It should be understood that the first side 40a is referring to a transversally extending side of the lower front frame member 40.

Similarly, the lower front frame member 40 comprises a first and a second dowel 41b, 42b on a second side 40b. It should be understood that the second side 40b is referring to a transversally extending side of the lower front frame member 40. The first and second sides 40a, 40b are opposing sides of the lower front frame member 40.

The first and second dowel 41a, 42a on the first side 40a of the lower front frame member 40, are inserted into the insertion points 11a3, 12a3 of the respective recess 11a, 12a. Once the dowels 41a, 42a are positioned inside their associated insertion points 11a3, 12a3, the dowels 41a, 42a are transferred to the second locking portions 11a2, 12a2 of the respective recess 11a, 12a by a sliding movement along the direction L2, as shown in FIG. 3b.

The first and second dowel 41b, 42b on the second side 40b of the lower front frame member 40, are inserted into the insertion points 11b3, 12b3 of the respective recess 11b, 12b. Once the dowels 41b, 42b are positioned inside their associated insertion points 11b3, 12b3, the dowels 41b, 42b are transferred to the second locking portions 11b2, 12b2 of the respective recess 11b, 12b by a sliding movement along the direction L2, as shown in FIG. 3b.

Continuing with FIG. 3b, once the dowels 41a-b, 42a-b of the lower front frame member 40 have been transferred to the second locking portions 11a2, 11b2, 12a2, 12b2 of the respective recess 11a-b, 12a-b by a sliding movement along the direction L2, the lower front frame member 40 is locked in place and abuts the installed height adjustment members 30a-b. In this context this may be referred to as that a projected distance L1d, as measured along the first direction L1, between the first locking portion 11a1, 11b1, 12a1, 12a1 and second locking portion 11a2, 11b2, 12a2, 12a2. is such that, when installed, the respective height adjustment member 30a-b abuts the lower front frame member 40 whereby the respective height adjustment member 30a-b is by the lower front frame member 40 prevented from being released by a movement in a direction opposite to the first direction L1. Hence, in this sense, abuts refers to the height adjustment member 30a-b and the lower front frame member 40 exerting a force on to each other along respectively in oppositely the first direction L1.

It may in this context be clarified that in the preferred embodiment, the dowels 30a1, 30a2, 30b1, 30b2 of the respective height adjustment member 30a-b) are configured to be inserted into the insertion portion (11a3, 11b3, 12a3, 12b3 of the respective recess 11a-b, 12a-b and to be transferred to the first locking portion 11a1, 11b1, 12a1, 12a1 of the respective recess 11a-b, 12a-b before the dowels 41a, 42a, 41b,42b of the lower front frame member 40 are configured to be inserted into the insertion portion 11a3, 11b3, 12a3, 12b3 of the respective recess 11a-b, 12a-b and to be transferred to the second locking portion 11a2, 11b2, 12a2, 12a2 of the respective recess 11a-b, 12a-b.

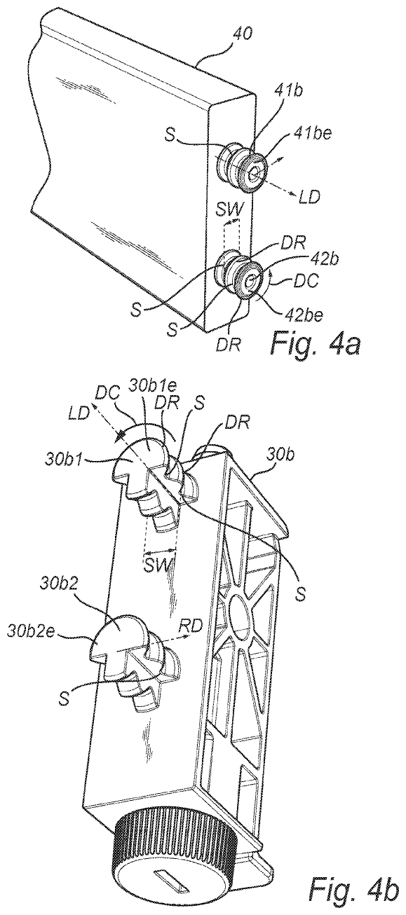

As can be seen in FIG. 4a, the first and second dowels 41a-b, 42a-b of the lower front frame member 40 are illustrated in greater details. The first dowels 41a, 41b are positioned at a top portion of the respective opposing sides 40b-a of the lower front frame member 40. The second dowels 42a, 42b are positioned at a lower portion of the respective opposing sides 40b-a of the lower front frame member 40. Each of the dowels 41a-b, 42a-b are formed in such a way that, when installed, they fit firmly into their associated second locking portions 11a2, 11b2, 12a2, 12b2. The dowels 41a-b, 42a-b on each side 40a-b of the lower front frame member 40 may extend outwardly from a major surface of each of the side 40a-b to which they are attached. Each set of dowels 41a-b, 42a-b on each side 40a-b of the lower front frame member 40 may preferably extend in the same direction.

The dowels 41a-b, 42a-b may be attached to a respective side 40a-b by means of e.g., adhesive, screwing the dowels 41a-b, 42a-b into the lower front frame member 40, or be integrally formed with the lower front frame member 40.

FIG. 4a illustrates dowels 41a-b, 42a-b of the lower front frame member 40 having a circular cross section, an extension along a longitudinal centreline extending through each of the dowels 41a-b, 42a-b, and having radially extending grooves. The dowels 41a-b, 42a-b in FIG. 4a have two radially extending grooves being substantially equidistant but are not limited to merely having two radially extending grooves being substantially equidistant. For instance, the dowels 41a-b, 42a-b may have e.g. three, or four radially extending grooves, while being at a varying distance in relation to each other. As such, the skilled person in the art realizes there are no limitations to the amount of grooves that the dowels 41a-b, 42a-b may have. The dowels 41a-b, 42a-b are not limited to a circular cross section as long as the recesses 11a-b, 12a-b are formed to accommodate different cross sections of the dowels 41a-b, 42a-b. For instance, the dowels 41a-b, 42a-b may have cross sections being e.g. wedge-formed, hexagonal, square, rectangular, triangular, octagonal, or any other cross sections. The dowels 41a-b, 42a-b are preferably identical.

The first dowel 30a1 of the first height adjustment member 30a may be attached to a top portion of the first height adjustment member 30a, and may extend outwardly from a major surface of the first height adjustment member 30a. The second dowel 30a2 may be attached to a lower portion of the first height adjustment member 30a, and may extend outwardly from a major surface of the first height adjustment member 30a. The first and the second dowel 30a1, 30a2 may preferably extend in the same direction.

The first dowel 30b1 may be attached to a top portion of the second height adjustment member 30b, and may extend outwardly from a major surface of the first height adjustment member 30b. The second dowel 30b2 may be attached to a lower portion of the first height adjustment member 30b, and may extend outwardly from a major surface of the first height adjustment member 30b. The first and the second dowel 30b1, 30b2 may preferably extend in the same direction.

The dowels 30a1, 30a2, 30b1, 30b2 may be attached to a respective height adjustment member 30a-b by means of e.g., adhesive, screwing the dowels 30a1, 30a2, 30b1, 30b2 into a major surface of a respective height adjustment member 30a-b, or be integrally formed with a major surface of a respective height adjustment member 30a-b. In the preferred embodiment, a body portion of the height adjustment members 30a-b is formed by moulding, such as injection moulding, of a plastic material, with the dowels 30a1, 30a2, 30b1, 30b2 being integrally formed with the body portion in said moulding.

The dowels 30a1, 30a2, 30b1, 30b2, of a height adjustment member 30a-b may have a circular cross section, an extension along a longitudinal centreline extending through each of the dowels 30a1, 30a2, 30b1, 30b2, and may have radially extending grooves. The dowels 30a1, 30a2, 30b1, 30b2 may have two radially extending grooves being substantially equidistant but are not limited to merely having two radially extending grooves being substantially equidistant. For instance, the 30a1, 30a2, 30b1, 30b2 may have e.g. three, or four radially extending grooves, while being at a varying distance in relation to each other. As such, the skilled person in the art realizes there are no limitations to the amount of grooves that the dowels 30a1, 30a2, 30b1, 30b2 may have. The dowels 30a1, 30a2, 30b1, 30b2 are not limited to a circular cross section as long as the recesses 30a1, 30a2, 30b1, 30b2 are formed to accommodate different cross sections of the dowels 30a1, 30a2, 30b1, 30b2. For instance, the dowels 30a1, 30a2, 30b1, 30b2 may have cross sections being e.g. wedge-formed, hexagonal, square, rectangular, triangular, octagonal, or any other cross sections.

The dowels 30a1, 30a2, 30b1, 30b2 are preferably identical.

FIG. 4b shows the dowels 30a1, 30a2, 30b1, 30b2 having portions thereof along the longitudinal centreline extending through each of the dowels 30a1, 30a2, 30b1, 30b2 being omitted. This is provided to take into account that it is beneficial to have a uniform thickness of polymer material such that there is not an un-even shrinking during the cooling of the moulded parts.

FIGS. 5a-b show the recesses 11a-b, 12a-b positioned at a front lower corner portion 10aFLCP, 10bFLCP of a respective side wall 10a-b. FIGS. 5a-b show the recesses 11a-b, 12a-b being identical. However, that may not always be the case. FIGS. 5a-b specifically show the respective recesses 11a-b, 12a-b having a circular insertion portion 11a3, 11b3, 12a3, 12b3. The shape of the insertion portion 11a3, 11b3, 12a3, 12b3 is not limited to a circular form, but may be e.g., hexagonal, square, rectangular, triangular, octagonal, or any other forms that would still allow the height adjustment members 30a-b and the lower front frame member 40 to be attached to the front lower corner portions 10aFLCP, 10bFLCP of the side walls 10a-b.

Moreover, FIGS. 5a-b show the first locking portion 11a1, 11b1, 12a1, 12a1 extending from the insertion portion 11a3, 11b3, 12a3, 12a3 in a first direction L1, comprising a portion gradually tapering and ending with a circular end portion. As such, once performing a sliding movement of the inserted height adjustment member 30a-b along the direction L1 from the insertion portions 11a3, 11b3, 12a3, 12b3 towards the respective first locking portions 11a1, 11b1, 12a1, 12a1, the dowels 30a1, 30a2, 30b1, 30b2 of a respective height adjustment member 30a-b gradually become movably limited in a direction transverse to the direction L1 until the dowels 30a1, 30a2, 30b1, 30b2 have reached the circular end portion of the respective first locking portions 11a1, 11b1, 12a1, 12a1.

Additionally, FIGS. 5a-b show the second locking portion 11a2, 11b2, 12a2, 12b2 extending from the insertion portion 11a3, 11b3, 12a3, 12b3 in a second direction L2, comprising a portion gradually tapering and ending with a circular end portion. As such, once performing a sliding movement of the inserted lower front frame member 40 along the direction L2 from the insertion portions 11a3, 11b3, 12a3, 12b3 towards the respective second locking portions 11a2, 11b2, 12a2, 12b2, the dowels 41a-b, 42a-b of a respective lower front frame member 40 gradually become movably limited in a direction transverse to the direction L2 until the dowels 41a-b, 42a-b have reached the circular end portion of the respective second locking portions 11a2, 11b2, 12a2, 12b2.

As is shown in the drawings, the respective insertion portion 11a3, 11b3, 12a3, 12b3 of each recess 11a-b, 12a-b has an insertion portion width IPW as measured in a direction being transverse to a depth direction DD and as measured transverse to the first direction L1 and as measured transverse to the second direction L2.

The respective first locking portion 11a1, 11b1, 12a1, 12a1 and the respective second locking portion 11a2, 11b2, 12a2, 12b2 each has opposing recess side walls SW1, SW2, which faces each other and which each has an extension along the depth direction DD and along the first respectively the second direction L1, L3. Each of the opposing recess side walls SW1, SW2 is preferably provided with at least one ridge R1, R2 with each ridge R1, R2 being located at a ridge depth RD, as seen along the depth direction DD, and having a longitudinal extension LR along the shelf sliding direction L3 and a height HR extending from the respective recess side wall SW1, SW2 towards an opposing ridge R2, R1 of the opposing recess side wall SW2, SW1, and at least one valley V1, V2 located at a valley depth VD, the valley depth VD being greater than the ridge depth RD. A locking portion width LPW formed by a shortest distance SDR between opposing ridges R1, R2 is smaller than the insertion portion width IPW and is smaller than a shortest distance SDV between opposing valleys V1, V2.

Continuing with FIGS. 5a-b, which show the angle between the first locking portions 11a1, 11b1, 12a1, 12a1 and the second locking portions 11a2, 11b2, 12a2, 12b2 being substantially 90 degrees. However, the angle between the first locking portions 11a1, 11b1, 12a1, 12a1 and the second locking portions 11a2, 11b2, 12a2, 12b2 is not limited to a specific angle. The skilled person realizes that the recesses 11a-b, 12a-b may be dimensioned to reach a condition in which the respective height adjustment member 30a-b abuts the lower front frame member 40 whereby the respective height adjustment member 30a-b is by the lower front frame member 40 prevented from being released by a movement in a direction opposite to the first direction L1.

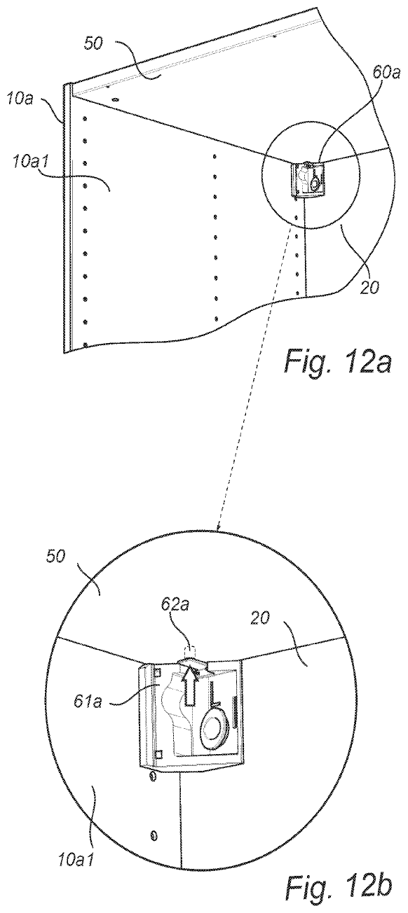

FIG. 8a shows a shelf locking member 60a-b each having a body part 61a-b configured to be attached to a side wall 10a-b and a dowel 62a-b movably connected to the respective body part 61a-b. The dowel 62a-b is movable between a shelf insertion position in which a shelf 50 is insertable between the side walls 10a-b to the intended installed position of the shelf 50 and a shelf locking position in which the dowel 62a-b is inserted into and interacts with a recess 55a-b formed in a downwardly facing major surface 501 of the shelf 50. This shelf locking position is best shown in FIG. 12b. This configuration prevents the shelf 50 from being removed from the intended installed position of the shelf 50. In the disclosed embodiment, the respective dowel 62a-b is arranged on an arm 63a-b being flexibly connected to the body portion 61a-b. The arm 63a-b is movable between a shelf insertion position in which the arm 63 is folded relative to the body portion 61a-b such that the dowel 62a-b is in its shelf insertion position allowing a shelf 50 to be inserted between the side walls 10a-b to the intended installed position of the shelf 50. Once the shelf 50 has been positioned in the installed position, the flexible arm 63a-b is movable to a shelf locking position in which the dowel 62a-b is moved to its and shelf locking position and becomes inserted into the recess 55a-b. The body portion 61a-b is also provided with protrusions 64a-b, 65a-b configured to keep the flexible arm 63a-b in the shelf insertion position. In the disclosed embodiment, the arm 63a-b is configured to manually be positioned in the shelf insertion position. However, it is also conceivable that the flexible arm 63a-b or the dowel 62a-b is provided with a cam surface configured to interact with the leading edge, i.e., the rear edge, of the shelf 50 such that the dowel 62a-b automatically becomes positioned in the shelf insertion position as the shelf insertion occurs. It is also conceivable that the dowel 62a-b is positioned in the shelf insertion position already from the beginning; from the beginning in the sense that the shelf locking member 60a-b is delivered to the user in a state where the dowel 62a-b is pre-set into the shelf insertion position. In the disclosed embodiment, the arm 63a-b is configured to manually be positioned into the shelf locking position once the shelf 50 has reached the intended installed position. However, it is also conceivable that the flexible arm 63a-b, the dowel 62a-b or the protrusions 64a-b, 65a-b is provided with a cam surface interacting with the downwardly facing major surface 501 of the shelf 50 such that the flexible arm 63 is automatically released from the protrusions 64a-b, 65a-b. This release of the arm 63a-b may e.g., occur as soon as the leading edge, i.e., the rear edge, of the shelf 50 has passed dowels 62a-b such that the dowels 62a-b slides along the downwardly facing major surface 501 of the shelf 50 until the shelf 50 reaches the intended installed position and the dowels 62a-b may become inserted into the recesses 55a-b.

The furniture module 1 may comprise at least two shelf locking members 60a-b. As seen in FIGS. 8b-c, each of the shelf locking member 60a-b is configured to be attached to a respective one of the two opposing side walls 10a-b. In FIG. 8c, the shelf locking member 60a-b is attached to a respective one of the two opposing side walls 10a-b by means of pins, being attached to the respective body part 61a-b, inserted into transversally extending openings side walls 10a-b. The skilled person realizes that the shelf locking member 60a-b may be attached to a respective one of two opposing side walls 10a-b by equally effective means commonly used in the art.

FIG. 9a-d illustrates the stages of installing the shelf 50 to the furniture module 1. The shelf 50 is configured to be positioned between the side walls 10a-b. The shelf 50 is not limited to be positioned in a respective specific portion between the side walls 10a-b but is preferably positioned between a respective top portion of the side walls 10a-b. The shelf is provided with a front dowel 53a-b on each side 50a-b of the shelf 50. The shelf is also provided with a central dowel 54a-b on each side 50a-b of the shelf 50. The shelf 50 preferably have a substantially rectangular shape as seen from above.

As best shown in FIG. 9b, each of the opposing side walls 10a-b comprises a front recess 13a-b and a central recess 14a-b which are formed on an inwardly facing major surface 10a1, 10b1 facing the opposing side wall 10b, 10a. Each of the front recesses 12a-b is positioned in a front top corner portion of the respective side wall 10a-b. Each of the central recesses 14a-b is positioned in a central top portion of the respective side wall 10a-b.

However, the front recesses 13a-b and the central recesses 14a-b may be arranged anywhere along the vertical extension of the respective side wall 10a-b. Thus, each of the front recesses 13a-b may be positioned along the longitudinally extending edge as a mid front recess 13a-b, or a lower front recess 13a-b. Each of the central recesses 14a-b may be positioned in a central mid portion or central lower portion of the respective side wall 10a-b. In one embodiment, the front dowel 53a-b and the central dowel 54a-b are each configured to be inserted into its associated front and central recesses 13a-b, 14a-b arranged in the longitudinal, vertical extension of the side walls 10a-b.

The front top corner recess and the central top portion recesses 13a-b, 14a-b each comprises an insertion portion 13a3, 13b3, 14a3, 14b3 and a locking portion 13a1, 13b1, 14a1, 14b1 extending from the insertion portion 11a3, 11b3, 12a3, 12a3 in a third direction L3. In the preferred embodiment, this third direction L3 is substantially horizontal. As mentioned above, in the preferred embodiment the first direction L1 is substantially horizontal. Thus, in the preferred embodiment, the first and the third directions L1, L3 are substantially parallel to each other.

The installation of the shelf 50 will now be described in detail in accordance with FIGS. 9a-d.

FIG. 9a illustrates the insertion of the shelf 50 between a top portion of the side walls 10a-b. The flexible rear wall panel arrangement 20 is configured to allow the opposing side walls 10a-b to assume a shelf installation position. Continuing with FIG. 9a, a user installing the furniture module 1 attaches a shelf locking member 60a-b in a rear top corner portion of a side wall 10a-b. Then, the user inserts the shelf 50 with an inclined, in relation to the directions L1, L3, movement. In this position, the front portions of the side walls 10a-b are at a greater horizontal distance from each other than a horizontal distance between rear portions of the side walls 10a-b.

FIG. 9b illustrates the inclined positioned shelf 50 being moved to a substantially horizontal position.

FIG. 9c displays the effect of the front portions of the side walls 10a-b being at a greater horizontal distance from each other than a horizontal distance between rear portions of the side walls 10a-b as this allows the shelf 50 to fit between a top portion of the side walls 10a-b thereby allowing the shelf 50 to be inserted by a movement along the first direction L1 until the dowels 53a-b, 54a-b reaches the respective associated recess 13a-b, 14a-b.

FIG. 9d illustrates that, after the respective dowel 53a-b, 54a-b has been inserted into the insertion portion 13a3, 13b3, 14a3, 14b3 of the respective recess 13a-b, 14a-b, the shelf 50 may be further moved along the third direction L3 such that the respective dowel 53a-b, 54a-b is transferred into the locking portion 13a1, 13b1, 14a1, 14a1 of the respective recess 13a-b, 14a-b.

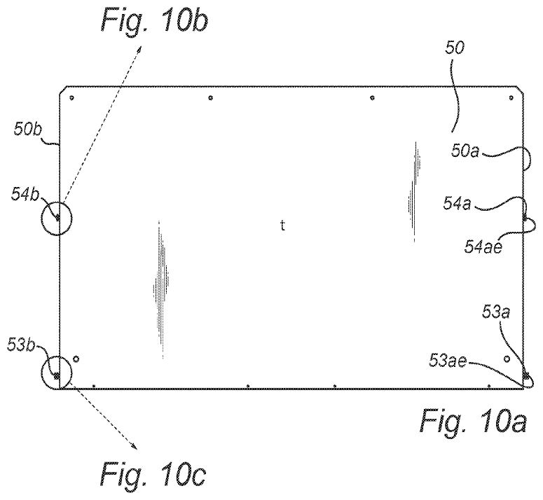

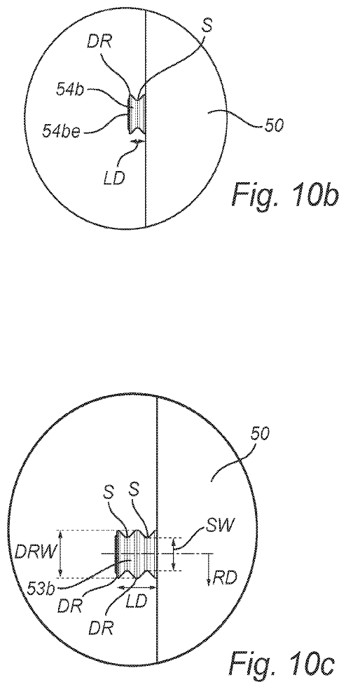

Turning to FIGS. 10a-b, it is shown that the front dowel 53a-b on each side 50a-b of the shelf 50 may extend a first distance 53ad1, 53bd1 from the respective side 50a-b of the shelf 50 to a respective free end 53ae, 53be of the respective dowel 53a, 53b. Further, the central dowel 54a-b may extend on each side 50a-b of the shelf 50 a second distance 54ad2, 54bd2 from the respective side 50a-b of the shelf 50 to a respective free end 54ae, 54be of the respective dowel 54a, 54b. The first distance 53ad1, 53bd1 is greater than the second distance 54ad2, 54bd2.

When inserting the shelf 50 between a top portion of the side walls 10a-b, the opposing side walls 10a-b assumes a shelf installation position during which a distance between a front top corner of a respective opposing side wall 10a-b is greater than a distance between a central top portion of a respective opposing side wall 10a-b, and which in turn is greater than a distance between a rear top corner portion of a respective side wall 10a-b. By the distance 53ad1, 53bd1 being greater than the second distance 54ad2, 54bd2, the dowels 53a-b, 54a-b of the shelf 50 may reach the respective associated recess 13a-b, 14a-b synchronously, hence allowing for the shelf 50 to be properly fitted between a top portion between the opposing side walls 10a-b. For instance, the distance 53ad1, 53bd1 being greater than the second distance 54ad2, 54bd2 is best illustrated in FIGS. 10b-c as the front dowels 53a-b of the shelf 50 is approximately twice a length of the central dowels 54a-b, the length of each of respective dowels 53a-b, 54a-b being defined as an extension along a longitudinal centreline extending through each of respective dowels 53a-b.

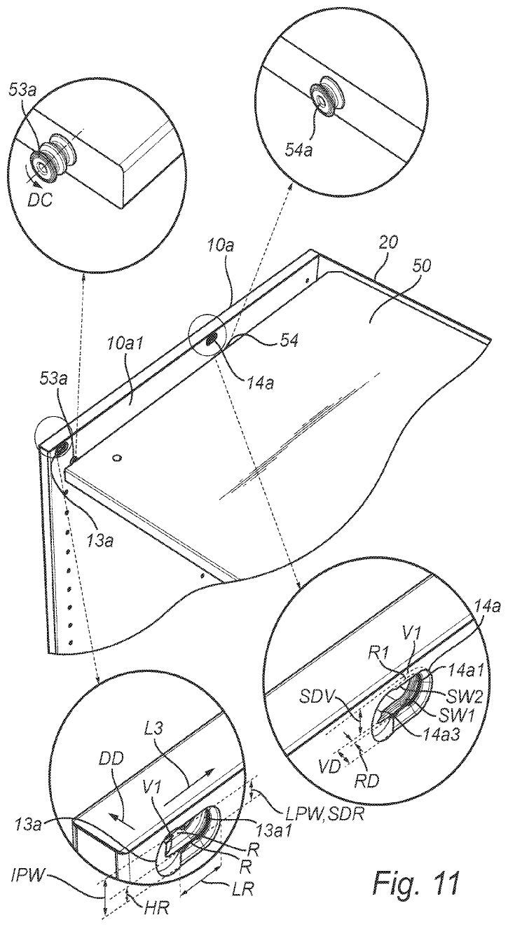

In FIG. 11, the recesses 13a-b, 14a-b of each of the respective opposing side walls 10a-b are shown in greater detail.

Each of the opposing side walls 10a-b comprises a front recess 13a-b and a central recess 14a-b which are formed on an inwardly facing major surface 10a1, 10b1 facing the opposing side wall 10b, 10a. The front recess 13a-b and the central recess 14a-b are positioned in a front top corner portion, respectively a central top portion of the respective side wall 10a-b.

As mentioned earlier, the front top corner recess and the central top portion recesses 13a-b, 14a-b each comprises an insertion portion 13a3, 13b3, 14a3, 14b3 and a locking portion 13a1, 13b1, 14a1, 14b1 extending from the insertion portion 13a3, 13b3, 14a3, 14a3 in a third direction L3.

In this context it may be noted that in FIG. 11, the top shelf 50 has solely for clarity reason been moved a distance away from the side wall panel 10a.

The process of realizing the installation of the shelf 50 will now be described in greater details.

As seen in FIG. 9d, after the respective dowel 53a-b, 54a-b has been inserted into the insertion portion 13a3, 13b3, 14a3, 14b3 of the respective recess 13a-b, 14a-b, the shelf 50 may be further moved along the third direction L3 such that the respective dowel 53a-b, 54a-b is transferred into the locking portion 13a1, 13b1, 14a1, 14a1 of the respective recess 13a-b, 14a-b. From this stage, having attached the shelf locking member 60a-b to a rear corner portion of the side wall 10a-b, the dowel 62a-b of the shelf locking member 60a is moved between the shelf insertion position, in which the shelf 50 is insertable between the side walls 10a-b to the intended installed position of the shelf 50, to the shelf locking position in which the dowel 62a-b interacts with the recess 55a-b formed in the downwardly facing major surface 501 of the shelf 50. By doing this, the shelf 50 is prevented from performing a sliding movement in a direction opposite to the direction L3. In other words, the shelf 50 is prevented from being removed from the intended installed position of the shelf 50.

Even though it is preferred that the furniture module is designed in accordance with the disclosure in the detailed disclosure of preferred embodiments and the appended drawings, it should be noted that a specific preferred embodiment of a specific component does not necessarily have to be combined with a specific embodiment of another component. Thus, advantages associated with a specific embodiment, including one or more features, of a specific component may be accomplished even though the other component(s) is/are designed in accordance with the more general disclosure under the summary of the invention rather than being defined in accordance with the specific embodiment disclosed in the detailed description.

It is contemplated that there are numerous modifications of the embodiments described herein, which are still within the scope of the invention as defined by the appended claims.

1-16. (canceled)

17. A furniture module, comprising:
two opposing side walls being interconnected by a rear wall panel arrangement,
a shelf configured to be positioned between the side walls, preferably between a respective top portion of the side walls,
wherein the shelf is provided with a front dowel on each side of the shelf and a central dowel on each side of the shelf,
wherein the front dowel on each side of the shelf extends a first distance from the respective side of the shelf to a respective free end of the respective dowel and the central dowel extends on each side of the shelf a second distance from the respective side of the shelf to a respective free end of the respective dowel, wherein the first distance is greater than the second distance, and wherein the front dowel and the central dowel are each configured to be inserted into associated front and central recesses of a respective portion of the side walls.

18. The furniture module according to claim 17,
wherein each of the opposing side walls comprises the front recess and the central recess which are formed on an inwardly facing major surface facing the opposing side wall and which are positioned in a front portion, respectively a central portion of the respective side wall, preferably in a front top portion respectively a central top portion of the respective side wall,
wherein the front recesses and the central recesses each comprises an insertion portion and a locking portion extending from the insertion portion in a shelf sliding direction,
wherein the rear wall panel arrangement is configured to allow the opposing side walls to assume a shelf installation position in which front portions of the side walls are at a greater horizontal distance from each other than a horizontal distance between rear portions of the side walls thereby allowing the shelf to be inserted by a movement at least partly along the shelf sliding direction until the dowels reach the respective associated front and central recess and, after the respective dowel has been inserted into the insertion portion of the respective front and central recess, be further moved along the shelf sliding direction such that the respective dowel is transferred into the locking portion of the respective front and central recess.

19. The furniture module according to claim 18,
wherein the respective insertion portion of each front and central recess has an insertion portion width as measured in a direction being transverse to a depth direction and being transverse to the shelf sliding direction,
wherein the respective first locking portion and the respective second locking portion of each front and central recess has opposing recess side walls, which faces each other and which each has an extension along the depth direction and along the shelf sliding direction,
wherein each of the opposing recess side walls is provided with
at least one ridge with each ridge being located at a ridge depth, as seen along the depth direction, and having a longitudinal extension along the shelf sliding direction and a height extending from the respective recess side wall towards an opposing ridge of the opposing recess side wall, and
at least one valley located at a valley depth, the valley depth being greater than the ridge depth,
wherein a locking portion width formed by a shortest distance between opposing ridges is smaller than the insertion portion width and is smaller than a shortest distance between opposing valleys.

20. The furniture module according to claim 17,
wherein each dowel comprises, as seen along a longitudinal extension of the respective dowel extending from the respective side of the shelf to a respective free end of the respective dowel, a stem having a stem width followed by a least one dowel ridge, the dowel ridge having an extension in a radial direction of the respective dowel and extending along at least a portion of a circumference of the respective dowel.

21. The furniture module according to claim 17, further comprising at least one shelf locking member each having a body part configured to be attached to a side wall and a dowel connected to the respective body part, the dowel being configured to interact with a recess formed in a downwardly facing major surface of the shelf and thereby prevents the shelf from being removed from an intended installed position of the shelf, wherein preferably the dowel is movably connected to the respective body part such that the dowel is movable between a shelf insertion position, in which the shelf is insertable between the side walls to the intended installed position of the shelf, and the shelf locking position in which the dowel interacts with a recess formed in a downwardly facing major surface of the shelf and thereby prevents the shelf from being removed from the intended installed position of the shelf.

22. The furniture module according to claim 21, wherein the furniture module comprises at least two shelf locking members each being configured to be attached to a respective one of the two opposing side walls.

23. The furniture module according to claim 17,
a first member configured to be attached to at least one of the side walls, and
a second member being configured to be attached to at least one of the side walls, preferably to both opposing side walls,
wherein the respective side wall comprises a first recess,
wherein the first recess comprises an insertion portion, a first locking portion extending from the insertion portion in a first direction, and a second locking portion extending from the insertion portion in a second direction, the second direction being different from the first direction, and
wherein the first recess is configured to receive a first dowel of the first member and a first dowel of the second member,
wherein preferably a projected distance, as measured along the first direction, between the first locking portion and the second locking portion is such that, when installed, the first member is by the second member prevented from being released by a movement in a direction opposite to the first direction.

24. The furniture module according to claim 23, wherein the respective side wall further comprises a second recess,
wherein the respective first recess on the respective side wall panel is positioned at a first height and the respective second recess on the respective side wall panel is positioned at a second height, wherein the first height is greater than the second height, wherein preferably a projection of the respective first recess onto a horizontal plane at least partly overlaps with a projection of the respective second recess onto the horizontal plane, wherein more preferably a geometrical line extending from a centre point of the respective insertion portion of the respective first recess to a centre point of the respective an insertion portion of the respective second recess extends substantially vertically downwardly.

25. The furniture module according to claim 23, wherein the first direction is substantially horizontal, and wherein the second direction is substantially vertical.

26. The furniture module according to claim 23, comprising two first members forming a first height adjustment member and a second height adjustment member configured to be attached to a respective opposing side wall at a front lower corner portion of the respective side wall on an inwardly facing major surface of the respective side wall facing the opposing side wall, and
the second member forming a lower front frame member being configured to be attached to both opposing side walls, at the respective front lower corner portion of the respective side wall on an inwardly facing major surface of the respective side wall facing the opposing side wall, and thereby interconnect the two opposing side walls at a front lower portion of the furniture module,
wherein each of the opposing side walls comprises a first and a second recess which are formed on an inwardly facing major surface facing the opposing side wall and which are positioned in the front lower corner portion of the respective side wall,
wherein the respective first and second recess at the front lower corner portions each comprises an insertion portion, a first locking portion extending from the insertion portion in a respective first direction, and a second locking portion extending from the insertion portion in a respective second direction, the respective second direction being different from the respective first direction, and
wherein, at the front lower corner portion of the respective side wall panel, the first recess of the first side wall is configured to receive a first dowel of the first height adjustment member and a first dowel on a first side of the lower front frame member, the second recess of the first side wall is configured to receive a second dowel of the first height adjustment member and a second dowel on a first side of the lower front frame member, the first recess of the second side wall is configured to receive a first dowel of the second height adjustment member and a first dowel on a second side of the lower front frame member, and the second recess of the second side wall is configured to receive a second dowel of the second height adjustment member and a second dowel on a second side of the lower front frame member.

27. The furniture module according to claim 26, wherein the dowels of the respective first and second height adjustment member are configured to be inserted into the insertion portions of the first respectively the second recess at the respective front lower corner portion and to be transferred to the first locking portion of the respective first and second recess.

28. The furniture module according to claim 26, wherein the dowels of the lower front frame member are configured to be inserted into the insertion portions of the first respectively the second recess at the respective front lower corner portion and to be transferred to the first locking portion of the respective first and second recess.

29. A method of attaching a shelf between two opposing side walls of a furniture module, the two opposing side walls being interconnected by a rear wall panel arrangement, preferably a flexible rear wall panel arrangement, the method comprising:
attaching a shelf between the two opposing side walls, preferably between a respective top portion of the respective side wall, by the rear wall panel arrangement allowing the opposing side walls to assume a shelf installation position in which front portions of the side walls are at a greater horizontal distance from each other than a horizontal distance between rear portions of the side walls and by moving the shelf along a shelf sliding direction until a front dowel on each side of the shelf and a central dowel on each side of the shelf reaches a respective associated front and central recess and, after the respective dowel has been inserted into an insertion portion of the respective front and central recess, be further moved along the shelf sliding direction such that the respective dowel is transferred into a locking portion of the respective front and central recess.

30. The method according to claim 29, further comprising:
attaching a first height adjustment member and a second height adjustment member to a respective one of the two opposing side walls at a front lower corner portion of the respective side wall on an inwardly facing major surface of the respective side wall facing the opposing side wall by inserting a first and a second dowel of the respective first and second height adjustment member into an insertion portion of a first and a second recess formed in the respective front lower corner portion of the respective side wall and sliding the respective first and second height adjustment member in a first direction such that the dowels of the respective first and second height adjustment member are transferred to a respective first locking portion of the respective first and second recess, and
attaching a lower front frame member to both opposing side walls by inserting a first and a second dowel on a first side of the lower front frame member and a first and a second dowel on a second side of the lower front frame member into the respective insertion portion of the first and second recesses formed in the respective front lower corner portion of the respective side wall and sliding the lower front frame member in a second direction, the second direction being different from the first direction, such that the dowels of the lower front frame member are transferred to a respective second locking portion of the respective recess first and second,
wherein preferably the actions of attaching the first height adjustment member and the second height adjustment member to a respective one of the two opposing side walls and of attaching the lower front frame member to both opposing side walls is performed before the action of attaching the shelf between the two opposing side walls.

31. The method according to claim 30, wherein the action of sliding the respective first and second height adjustment member in a first direction involves sliding the respective first and second height adjustment member in a substantially horizontal direction, and wherein the action of sliding the lower front frame member in a second direction involves sliding the lower front frame member in a substantially vertical direction.

32. The method according to claim 30, further comprising:
the respective first and second height adjustment member abutting the lower front frame member when the respective first and second height adjustment member and the lower front frame member has been attached to the respective front lower corner portion of the respective side wall whereby the respective first and second height adjustment member is by the lower front frame member prevented from being released by a movement in a direction opposite to the first direction.
